(19) United States
(12) Patent Application Publication
(10) Pub. No.: US 2015/0048795 A1
(43) Pub. Date: Feb. 19, 2015

(54) CHARGE CONTROL APPARATUS AND CHARGE CONTROL METHOD

(71) Applicant: NEC ENERGY DEVICES, LTD., Kanagawa (JP)

(72) Inventor: Yasushi Hashimoto, Kanagawa (JP)

(73) Assignee: NEC ENERGY DEVICES, LTD., Kanagawa (JP)

(21) Appl. No.: 14/391,193

(22) PCT Filed: Mar. 29, 2013
(86) PCT No.: PCT/JP2013/059536

§ 371 Date: Oct. 8, 2014

(30) Foreign Application Priority Data
Apr. 24, 2012 (JP) 2012-098645

(51) Int. Cl. H02J 7/00

(52) U.S. Cl. CPC H02J 7/0021; H02J 7/0034; H02J 7/0052; H02J 7/007
USPC 320/126

(57) ABSTRACT

A charge control apparatus which includes charger 120 whose output voltage is variable and to which batteries 101A and 101B are connected in parallel, further includes: current detectors 105A and 105B that detect charging currents flowing to batteries 101A and 101B, and output the detected current values; maximum value detector 130 that selects the maximum value from among the output values of current detectors 105A and 105B, and outputs the selected value; and controller 140 that controls the output voltage of charger 120 such that the output value of maximum value detector 130 matches a setting value.

### TECHNICAL FIELD

The present invention relates to a technique of charging a plurality of batteries.

### BACKGROUND ART

Batteries capable of repetitive charging and discharging based on chemical reactions have been known. This type of battery has allowable upper limit currents. A charging current over the limit flowing therethrough degrades the batteries. Accordingly, when batteries are charged by a charger, the charging current needs to be controlled so that it does not exceed the upper limit current.

In the case of charging batteries, the batteries need to be charged by charging currents within ranges not exceeding the respective upper limit currents. Accordingly, the charging current needs to be controlled for each battery.

Patent Literature 1 describes a charge control apparatus that successively switches and charges batteries on a one-by-one basis.

FIG. 1 shows a configuration of a charge control apparatus. The charge control apparatus shown in FIG. 1 includes charger 120 that performs control at a constant current and a constant voltage, batteries 101A and 101B that are to be charged, switches 103A and 103B for switching the batteries to be charged, voltage detectors 102A and 102B that detect the voltages of batteries 101A and 101B, and controller 110 that controls switches 103A and 103B according to the detected voltage values and switches the batteries to be charged. The numbers of batteries, voltage detectors, and switches may be increased to support the number of batteries intended to be charged.

Controller 110 controls switches 103A and 103B to connect battery 101A or 101B to charger 120, and performs constant current control through charger 120. Here, it is assumed that battery 101A is connected to charger 120.

When the voltage value of battery 101A detected by voltage detector 102A reaches a setting voltage value, controller 110 controls switches 103A and 103B to switch the battery that is to be charged from battery 101A to battery 101B, and performs constant current control through charger 120.

When the voltage value of battery 101B detected by voltage detector 102B reaches a setting voltage value, controller 110 controls switches 103A and 103B to switch the battery that is to be charged from battery 101B to battery 101A, and performs constant voltage control through charger 120. This constant voltage control charges battery 101A until this battery is fully charged.

When battery 101A is fully charged, controller 110 controls switches 103A and 103B to switch the battery that is to be charged from battery 101A to battery 101B, and performs constant voltage control through charger 120. This constant voltage control charges battery 101B until this battery is fully charged.

Patent Literature 2 describes a charging system that charges an assembled lithium-ion battery that includes unit cells connected in series.

The charging system described in Patent Literature 2 includes a cell voltage adjuster that measures the voltages of respective unit cells and outputs signals representing measurement results, a battery monitoring controller that monitors the voltages of unit cells and controls charging currents flowing into the unit cells on the basis of the signal from the cell voltage adjuster, and a charging current limiter that adjusts the charging currents flowing into the assembled lithium-ion battery.

When the voltage of at least one unit cell reaches a reference value, the battery monitoring controller causes the charging current limiter to reduce stepwise the charging current flowing into the assembled lithium-ion battery. The cell voltage adjuster includes a charging current bypass circuit that bypasses the charging current flowing into a unit cell that is among unit cells connected in parallel and has a voltage reaching the reference value. This charging current bypass circuit prevents the unit cells from being overcharged.

### CITATION LIST

### Patent Literature

Patent Literature 1: JP2004-357481A
Patent Literature 2: JP2011-182479A

### SUMMARY OF INVENTION

The charge control apparatus described in Patent Literature 1 has the configuration in which batteries are successively switched and charged on a one-by-one basis. This configuration causes a problem in that the required charging time increases in proportion to the number of batteries that are to be charged.

Furthermore, the switches for switching the batteries that are to be charged are required to be provided for the respective batteries, thereby causing a problem of increasing the cost and size of the apparatus.

The charging system described in Patent Literature 2 has the configuration in which the entire assembled lithium-ion battery including unit cells connected in series is charged. Accordingly, the amount of increase in required charging time, which increases in proportion to the number of unit cells that are to be charged, is small.

Unfortunately, in the charging system described in Patent Literature 2, the cell voltage adjuster includes not only the function of measuring the voltage of each unit cell but also the charging current bypass circuit that bypasses the charging current flowing into a unit cell with a voltage reaching the reference value. This configuration causes a problem of increasing the cost and size of the apparatus.

Note that connecting batteries in parallel to one charger allows each battery to be charged at a time. However, in this case, voltages with the same value are applied to the respective batteries and these batteries are charged. Accordingly, the magnitudes of charging currents flowing into the respective batteries differ from each other. This difference causes a problem in that constant current control for maintaining the output current from the charger at a constant value causes currents having a value exceeding an allowable charging current value to flow into some batteries, thereby degrading and damaging the batteries.

It is an object of the present invention to provide a charge control apparatus and a charge control method that allow one charger to charge batteries at one time, that do not degrade or damage the batteries, and that can prevent increase in required charging time, increase in the cost of the apparatus and increase in the size of the apparatus.

In order to achieve the object, an aspect of the present invention provides a charge control apparatus which includes a charger whose output voltage is variable, a plurality of batteries being connected in parallel to the charger, the apparatus further including: a plurality of current detecting means that are provided for each of the batteries, each current detecting means being configured to detect a charging current flowing to each battery and to output the detected current value; maximum value detecting means that selects a maximum value from among output values of the plurality of current detecting means, and that outputs the selected value; and control means that controls an output voltage of the charger such that the output value of the maximum value detecting means matches a setting value.

Another aspect of the present invention provides a charge control apparatus which includes a charger whose output voltage is variable, a plurality of batteries being connected in parallel to the charger, the apparatus further including: a plurality of current detecting means that are provided for each of the batteries, each current detecting means being configured to detect a charging current flowing to each battery and to output the detected current value; a plurality of current error output means that are provided for each of the plurality of current detecting means, each current error output means being configured to output a value acquired by subtracting a setting value from the output value of each current detecting means; maximum value detecting means that selects a maximum value from among the output values of the plurality of current error output means, and that outputs the selected value; and control means that controls an output voltage of the charger such that the output value of the maximum value detecting means is zero.

Yet another aspect of the present invention provides a charge control method performed by a charge control apparatus which includes a charger whose output voltage is variable, a plurality of batteries being connected in parallel to the charger, the method including: detecting a charging current flowing to each of the batteries; and controlling an output voltage of the charger such that a maximum value from among detected values of the charging currents of the batteries matches a setting value.

Yet another aspect of the present invention provides a charge control method performed by a charge control apparatus which includes a charger whose output voltage is variable, a plurality of batteries being connected in parallel to the charger, the method including: detecting a charging current flowing to each of the batteries; acquiring a current error value by subtracting a setting value from the detected value of the charging current; and controlling an output voltage of the charger such that a maximum value from among the current error values of the batteries is zero.

### BRIEF DESCRIPTION OF DRAWINGS

FIG. 1 is a block diagram showing a configuration of a charge control apparatus described in Patent Literature 1.

FIG. 2 is a block diagram showing a configuration of a charge control apparatus of a first exemplary embodiment of the present invention.

FIG. 3 is a flowchart showing a procedure of charging control performed by the charge control apparatus shown in FIG. 2.

FIG. 4 is a characteristic diagram showing how the charging current changes due to the charging control by the charge control apparatus shown in FIG. 2.

FIG. 5 is a block diagram showing a configuration of a charge control apparatus of a second exemplary embodiment of the present invention.

FIG. 6 is a flowchart showing a procedure of charging control performed by the charge control apparatus shown in FIG. 5.

FIG. 7 is a circuit diagram showing a configuration of a maximum value detector adopted in a charge control apparatus of one example of the present invention.

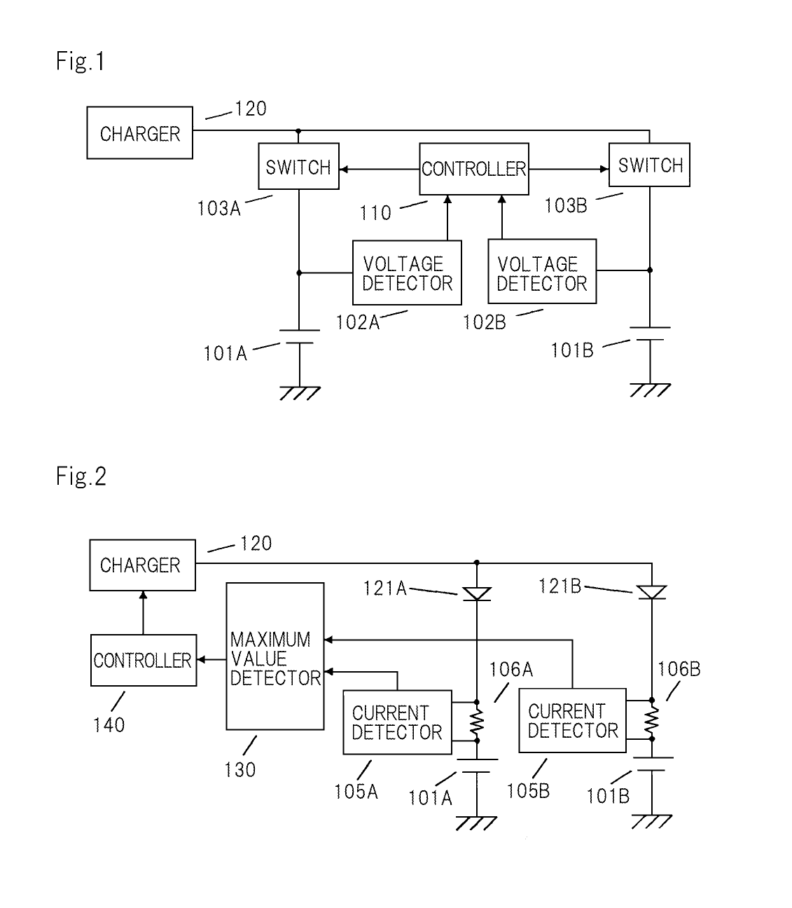

### REFERENCE SIGNS LIST

101A, 101B Battery
105A, 105B Current detector
106A, 106B Current detection resistor element
120 Charger
121A, 121B Reverse-current protector
130 Maximum value detector
140, 143 Charger controller
141A, 141B Error amplifier
142A, 142B Current setter
201 Pull-down resistor element
202A, 202B Operational amplifier
203A, 203B Diode

### DESCRIPTION OF EMBODIMENTS

Next, exemplary embodiments of the present invention are described with reference to the drawings.

### First Exemplary Embodiment

FIG. 2 is a block diagram showing a configuration of a charge control apparatus of a first exemplary embodiment of the present invention.

Referring to FIG. 2, the charge control apparatus charges two batteries 101A and 101B, and includes current detectors 105A and 105B, current detection resistor elements 106A and 106B, reverse-current protectors 121A and 121B, charger 120, maximum value detector 130, and controller 140.

Batteries 101A and 101B are connected in parallel to charger 120 having a variable output voltage.

An output line of charger 120 is connected to one end of reverse-current protector 121A, and connected to one end of reverse-current protector 121B.

The other end of reverse-current protector 121A is connected to battery 101A via current detection resistor element 106A. The other end of reverse-current protector 121B is connected to battery 101B via current detection resistor element 106B.

Reverse-current protectors 121A and 121B function to allow current to flow in only one direction and prevent reverse current from flowing from batteries 101A and 101B toward charger 120.

Current detector 105A detects a current flowing through current detection resistor element 106A (i.e., charging current for battery 101A), and supplies the detected value to maximum value detector 130. More specifically, current detector 105A detects the charging current by measuring the voltage across the opposite ends of current detection resistor element 106A.

Current detector 105B detects a current flowing through current detection resistor element 106B, i.e., charging current for battery 101B, and supplies the detected value to maximum value detector 130. More specifically, current detector 105B detects the charging current by measuring the voltage across the opposite ends of current detection resistor element 106B.

Maximum value detector 130 selects the maximum value from among the detected values of charging currents supplied from current detectors 105A and 105B, and outputs the selected value.

Controller 140 controls the output voltage (charging voltage) of charger 120 according to the output value (the maximum value among the detected values of charging current) of maximum value detector 130. More specifically, controller 140 controls the output voltage of charger 120 such that the output value of maximum value detector 130 matches a preset setting value.

Charger 120 is configured so as to allow the output voltage to be changed within a range not exceeding a preset maximum voltage value according to control by controller 140.

Batteries 101A and 101B are secondary batteries capable of repetitive charging and discharging, such as lithium-ion batteries and lithium polymer batteries, or high capacitance capacitors, such as electric double layer capacitors and lithium-ion capacitors.

Batteries 101A and 101B are provided with reverse-current protectors 121A and 121B, respectively. Accordingly, even if the voltages of batteries 101A and 101B are different from each other, current never flows from a battery having a high voltage to a battery having a low voltage.

The example shown in FIG. 2 is a configurational example in the case of charging two batteries. In the configuration shown in FIG. 2, in the case of charging at least three batteries, a current detection resistor element, a current detector, and a reverse-current protector are appropriately provided for each battery. In this case, maximum value detector 130 selects the maximum value from among the output values of the current detectors, and outputs the selected value.

Next, the operation of the charge control apparatus of this exemplary embodiment is described.

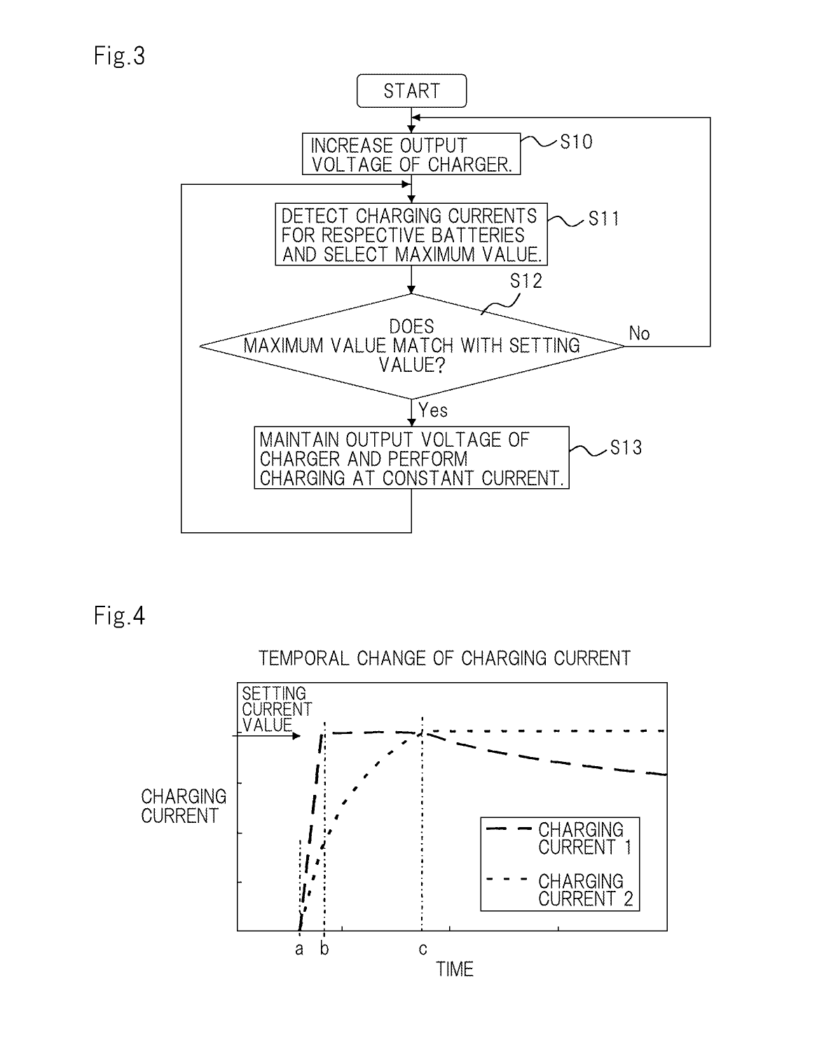

FIG. 3 is a flowchart showing a procedure of charging control. Hereinafter, referring to FIGS. 2 and 3, the operation of charging control is described.

At the start of charging, controller 140 increases the output voltage of charger 120 (step S10).

Next, current detectors 105A and 105B detect charging currents of respective batteries 101A and 101B, and maximum value detector 130 supplies controller 140 with the higher value (maximum value) between the detected values of charging currents from current detectors 105A and 105B (step S11).

Next, controller 140 determines whether the maximum value of charging currents from maximum value detector 130 matches a preliminarily held setting value or not (step S12).

If the determination in step S12 is “Yes”, controller 140 maintains the magnitude of the output voltage of charger 120 at a present value, and performs charging at a constant current (step S13). After step S13, the process in step S11 is performed.

If the determination in step S12 is “No”, the process in step S10 is performed. That is, control by controller 140 increases the output voltage of charger 120.

The processes in steps S10 to S13 are repeated. After the output voltage value of charger 120 reaches the maximum voltage value, charger 120 performs constant-voltage charging at the maximum voltage value.

FIG. 4 is a characteristic diagram showing how the charging current changes according to lapse of time by the charging control. In FIG. 4, charging current 1 indicated by a long broken line is the charging current for battery 101A, and charging current 2 indicated by a short broken line is the charging current for battery 101B. Here, the voltage of battery 101A is assumed to be lower than the voltage of battery 101B.

Controller 140 increases the output voltage of charger 120. More specifically, controller 140 gradually increases the output voltage of charger 120 while taking time allowing feedback to follow.

When the output voltage value of charger 120 reaches the voltage value of battery 101A whose voltage value is lower than that of battery 101B, the charging current starts to flow to battery 101A. Time “a” in FIG. 4 is a point in time when charging current starts to flow to battery 101A.

When the charging current starts to flow to battery 101A, current detector 105A detects the charging current for battery 101A. At this time, the charging current does not flow to battery 101B. Accordingly, maximum value detector 130 supplies controller 140 with the detected value of charging current at current detector 105A as the maximum value. Controller 140 then performs feedback control for the output voltage of charger 120 such that the maximum value of charging current from maximum value detector 130, which is the magnitude of charging current for battery 101A, matches the setting value.

According to the feedback control, the magnitude of charging current of current detector 105A matches the setting value. Time “b” in FIG. 4 is a point in time when the magnitude of charging current of current detector 105A matches the setting value.

When the magnitude of charging current of current detector 105A matches the setting value, controller 140 maintains the output voltage value of charger 120 at the present value, and performs charging at a constant current.

If the output voltage of charger 120 is increased more than that at the point in time (time “a”) when the charging current starts to flow to battery 101A, the charging current may sometimes start to flow also to battery 101B. In this case, the detected values of charging currents from current detectors 105A and 105B are supplied to maximum value detector 130. Maximum value detector 130 outputs, to controller 140, the higher value from among the detected values of charging currents from current detectors 105A and 105B.

At time “c” in FIG. 4, the magnitude of charging current for battery 101B (the detected value of charging current at current detector 105B) exceeds the magnitude of charging current for battery 101A (the detected value of charging current at current detector 105A). In this case, maximum value detector 130 outputs the detected value of charging current from current detector 105B to controller 140. Controller 140 then performs feedback control for the output voltage of charger 120 such that the maximum value of charging current from maximum value detector 130, which is the magnitude of charging current for battery 101B, matches the setting value.

According to the feedback control, if the charging current (charging current 1) for battery 101A is greater, the charging current value for battery 101A will be selected and constant current charging will be performed; if the charging current (charging current 2) for battery 101B is greater, the charging current value for battery 101B will be selected and constant current charging will be performed.

The charge control apparatus of this exemplary embodiment allows one charger to charge batteries with different capacities and states of charge at one time.

Furthermore, the magnitude of current flowing into each battery does not exceed the charging upper limit current value, and each battery can be charged at a charging time that is equivalent to that for charging one battery.

Moreover, the switches, that are adopted in the apparatus described in Patent Literature 1, and the charging current bypass circuit that is adopted in the system described in Patent Literature 2 are not required.

In general, the larger the size of a charger, the smaller is the volume and weight per unit charging capacity. Furthermore, the larger the size, the higher is the power efficiency of the charger that is to be simply produced. Accordingly, in comparison with a construction, in which, a charger having the capacity of one battery is provided for each battery and a construction in which a large charger having the capacities of batteries is provided, a reduction in size and weight, increase in efficiency, and reduction in cost can be achieved.

### Second Exemplary Embodiment

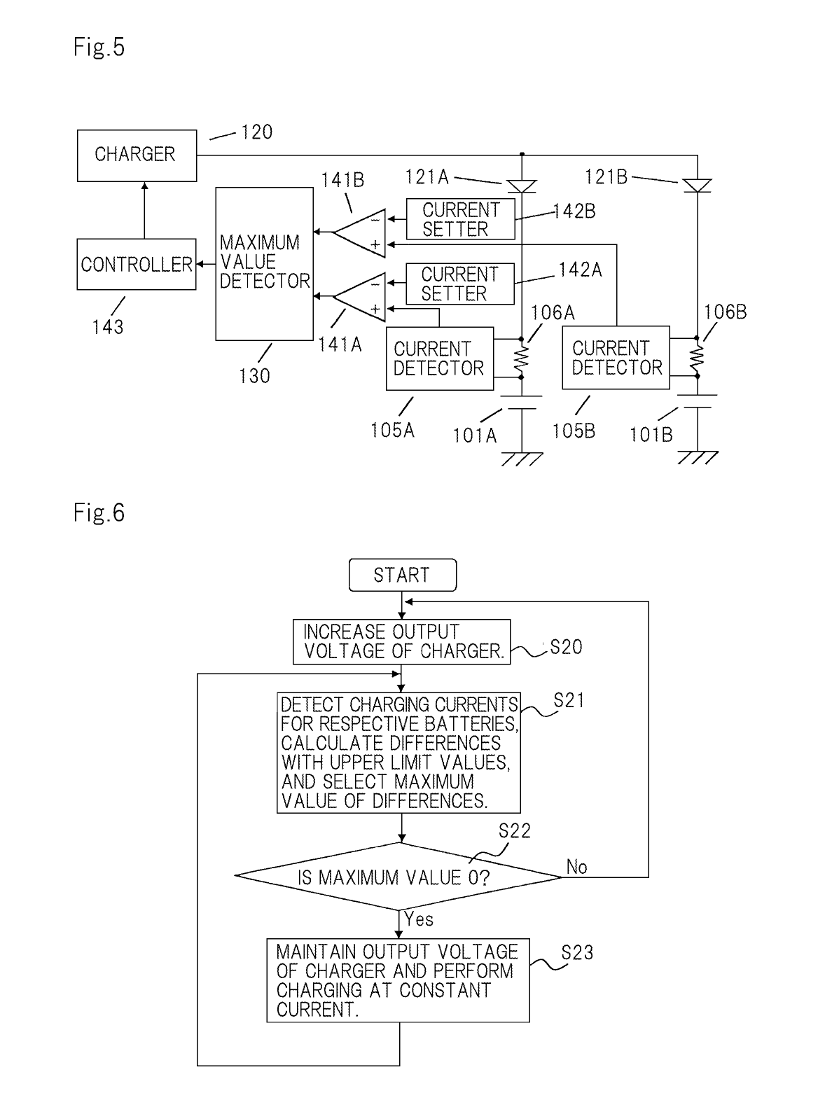

FIG. 5 is a block diagram showing a configuration of a charge control apparatus of a second exemplary embodiment of the present invention.

The charge control apparatus of this exemplary embodiment includes not only the configurational elements shown in FIG. 2 but also current setters 142A and 142B and error amplifiers 141A and 141B. This apparatus is different in this point from the apparatus of the first exemplary embodiment. In FIG. 5, the same signs are assigned to the same elements as those of the first exemplary embodiment. The description is omitted.

Current setter 142A outputs an upper limit value of the charging current for battery 101A. Current setter 142B outputs an upper limit value of the charging current for battery 101B. If the upper limit values of charging currents for respective batteries 101A and 101B are the same, the output values of current setters 142A and 142B are the same. If the upper limit value of charging current for battery 101A is different from the upper limit value of charging current for battery 101B, current setters 142A and 142B output respective values different from each other.

Error amplifier 141A receives the output of current setter 142A as one input while receiving the output of current detector 105A as the other input, and outputs the difference between these inputs. More specifically, error amplifier 141A outputs a value acquired by subtracting the output value (upper limit value) of current setter 142A from the output value of current detector 105A (the detected value of charging current for battery 101A).

If the detected value of charging current for battery 101A is higher than the upper limit value, the output value of error amplifier 141A is a positive value. In contrast, if the detected value of charging current for battery 101A is smaller than the upper limit value, the output value of error amplifier 141A is a negative value.

Error amplifier 141B receives the output of current setter 142B as one input while receiving the output of current detector 105B as the other input, and outputs the difference between these inputs. More specifically, error amplifier 141B outputs a value acquired by subtracting the output value (upper limit value) of current setter 142B from the output value of current detector 105B (the detected value of charging current for battery 101B).

If the detected value of charging current for battery 101B is higher than the upper limit value, the output value of error amplifier 141B is a positive value. In contrast, if the detected value of charging current for battery 101B is smaller than the upper limit value, the output value of error amplifier 141B is a negative value.

Maximum value detector 130 outputs, to controller 143, a higher value from amoung the output values of error amplifiers 141A and 141B as the maximum value of differences. In selection of the maximum value, the signs of the output values are considered. For instance, if all the values are negative, the value closest to the positive (with a smallest absolute value) is determined as the maximum value.

Controller 143 controls the output voltage of charger 120 such that the output value (maximum value) of maximum value detector 130 is zero.

The example shown in FIG. 5 is a configurational example in the case of charging two batteries. In the case of charging at least three batteries according to the configuration shown in FIG. 5, a current detection resistor element, a current detector, a reverse-current protector, a current setter, and an error amplifier are appropriately provided for each battery. In this case, maximum value detector 130 selects the highest value (maximum value) from among the output values of the error amplifiers and outputs the selected value.

The current setter and the error amplifier are separately provided. Alternatively, the current setter and the error amplifier may be configured as one functional block (current error output means). In this case, the current error output means may replace the current setter and simply hold the upper limit value of charging current.

Next, the operation of the charge control apparatus of this exemplary embodiment is described.

FIG. 6 is a flowchart showing a procedure of charging control. Hereinafter, referring to FIGS. 5 and 6, the operation of charging control is described.

At the start of charging, controller 143 increases the output voltage of charger 120 (step S20).

Next, current detectors 105A and 105B detect the charging currents of respective batteries 101A and 101B. Error amplifiers 141A and 141B output values acquired by subtracting the output values (upper limit values) of current setters 142A and 142B from the respective output values of current detectors 105A and 105B. Maximum value detector 130 then selects the higher value (maximum value) from among the output values of error amplifiers 141A and 141B and outputs the selected value (step S21).

Next, controller 143 determines whether the maximum value from the maximum value detector 130 is zero or not (step S22).

If the determination in step S22 is “Yes”, controller 143 maintains the output voltage value of charger 120 at the present value, and performs charging at a constant current (step S23). After step S23, the process in step S21 is performed.

If the determination in step S22 is “No”, the process in step S20 is performed. More specifically, control by controller 143 increases the output voltage of charger 120.

When the processes in steps S20 to S23 are repeated and the output voltage of charger 120 reaches the maximum voltage value, charger 120 performs constant-voltage charging at the maximum voltage.

The charge control apparatus of this exemplary embodiment also exerts operational effects analogous to those of the first exemplary embodiment.

### EXAMPLE 1

An example of the charge control apparatus of first exemplary embodiment is described as a first example of the present invention.

The charge control apparatus of this example has the configuration shown in FIG. 2. The configurational elements are configured as follows.

The maximum voltage value that charger 120 can supply is 4.2 V. The current supply capacity of charger 120 is 10 A at the maximum.

Each of reverse-current protectors 121A and 121B is made of an ideal diode circuit that is constructed using an FET.

Each of batteries 101A and 101B is made of a lithium-ion battery having a capacity of 10 Ah and an allowable charging current of 5 A, and its internal resistance is 10 mΩ. The open-circuit voltage of battery 101A is 3.50 V, and the open-circuit voltage of battery 101B is 3.55 V.

The resistance values of current detection resistor elements 106A and 106B are each 10 mΩ. Current detectors 105A and 105B multiply the respective voltages across the opposite ends of current detection resistor elements 106A and 106B by 100, and detect a voltage of 1 V per ampere.

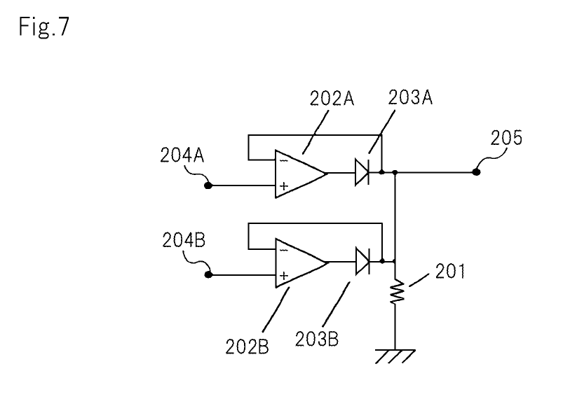

Maximum value detector 130 is made of a voltage follower circuit. FIG. 7 shows an example of maximum value detector 130.

Referring to FIG. 7, maximum value detector 130 includes operational amplifiers 202A and 202B, diodes 203A and 203B, and pull-up resistor element 201.

Each of operational amplifiers 202A and 202B is an amplifier with a voltage gain of one, and configures a voltage follower circuit. One input (“+” side input) of operational amplifier 202A is connected to input terminal 204A of maximum value detector 130. One input (“+” side input) of operational amplifier 202B is connected to input terminal 204B of maximum value detector 130.

The output of operational amplifier 202A is connected to one end of diode 203A. The other end of diode 203A is connected to the other input (“−” side input) of operational amplifier 202A and to output terminal 205 of maximum value detector 130.

The output of operational amplifier 202B is connected to one end of diode 203B. The other end of diode 203B is connected to the other input (“−” side input) of operational amplifier 202B and to a line that connects the other end of diode 203A and output terminal 205.

The line that connects the other ends of both diodes 203A and 203B to output terminal 205 is grounded via pull-up resistor element 201.

In maximum value detector 130 shown in FIG. 7, input terminals 204A and 204B are connected to the respective outputs of current detectors 105A and 105B. Maximum value detector 130 outputs the highest voltage from among the input voltages supplied to input terminals 204A and 204B.

Controller 140 is made of a PID control circuit, and controls the output voltage of charger 120 such that the output of maximum value detector 130 is a voltage value of 5 V equivalent to 5 A that is a setting charging current. Here, PID control combines proportional control, integral control and differential control, and achieves convergence to the setting value.

When the power of the charge control apparatus of this example is turned on, the output voltage of charger 120 gradually increases according to the command value from controller 140.

When the output voltage of charger 120 reaches 3.50 V that is the open-circuit voltage of battery 101A, charging current starts to flow to battery 101A. At this time, no charging current flows to battery 101B.

Current detector 105A detects the charging current for battery 101A. The detected value of charging current is supplied to controller 140 via maximum value detector 130. The detected value of charging current is smaller than the setting charging current value. Accordingly, controller 140 further increases the output voltage of charger 120.

When the output voltage of charger 120 reaches 3.55 V that is the open-circuit voltage of battery 101B, the charging current starts to flow also to battery 101B. At this time, the total of the resistance value of current detection resistor element 106A and the battery internal resistance value is 20 mΩ. Accordingly, a charging current of 2.5 A flows into battery 101A.

The charging current (2.5 A) for battery 101A is greater than charging current for battery 101B. Accordingly, maximum value detector 130 supplies controller 140 with the detected value (2.5 A) of charging current from current detector 105A. 2.5 A that is the detected value of charging current is smaller than a setting current value. Accordingly, controller 140 further increases the output voltage of charger 120.

When the output voltage of charger 120 reaches 3.60 V, the charging current for battery 101A is 5 A. At this time, the charging current for battery 101B is 2.5 A, and the total output current value from charger 120 is 7.5 A. Maximum value detector 130 supplies controller 140 with a detected value of 5 A that is the maximum value from among the detected values of charging currents of batteries 101A and 101B.

Since the detected value of charging current for battery 101A matches the setting current value, controller 140 maintains the output voltage of charger 120 constant and performs charging at a constant current.

As charging progresses and the open-circuit voltage of battery 101A increases, the charging current starts to decrease. However, controller 140 increases the output voltage of charger 120 such that the maximum value of charging current matches the setting current value.

As charging progresses, the charging current for battery 101A becomes large. Accordingly, the state of charge of battery 101A sometimes catches up with that of battery 101B. In this case, the open-circuit voltages of batteries 101A and 101B substantially match each other, and the charging currents also substantially match each other. Maximum value detector 130 selects a larger value from among the detected values of charging currents for batteries 101A and 101B even if the difference is significantly small, and outputs the selected value to controller 140.

The magnitudes of charging currents for batteries 101A and 101B approximately become 5 A, and charging is performed at the constant current. At this time, the magnitude of the total output currents of charger 120 is 10 A.

When the output voltage of charger 120 reaches 4.2 V, the charging current value falls below 5 A, controller 140 supplies charger 120 with a command value for further increasing the output voltage. However, even if charger 120 receives the command value from controller 140, this charger cannot output a voltage higher than 4.2 V. Accordingly, batteries 101A and 101B are charged at a constant voltage of 4.2 V.

If the output voltage value of charger 120 reaches 4.2 V before the magnitude of the charging current for battery 101B reaches that of the charging current for battery 101A, the charging voltage will not increase any more. Batteries 101A and 101B are charged at the constant voltage of 4.2 V. In this case, the magnitude of the charging current for battery 101B never reaches the setting current value, and the state transitions to constant-voltage charging.

In every case, the time required to charge the batteries substantially matches the time required to charge battery 101A that is in a low state of charge. Accordingly, charging the batteries never increases the charging time.

### EXAMPLE 2

An example of the charge control apparatus of the second exemplary embodiment is described as a second example of the present invention.

The charge control apparatus of this example has the configuration shown in FIG. 5. The configurational elements are configured as follows.

The maximum voltage value that charger 120 can supply is 4.2 V. The current supply capacity of charger 120 is 10 A at the maximum.

Each of reverse-current protectors 121A and 121B is made of an ideal diode circuit that is constructed using an FET.

Battery 101A is made of a lithium-ion battery having a capacity of 10 Ah and an allowable charging current of 5 A, and its internal resistance is 10 mΩ. The open-circuit voltage of battery 101A is 3.50 V.

Battery 101B is made of a lithium-ion battery having a capacity of 5 Ah and an allowable charging current of 2.5 A, and its internal resistance is 20 mΩ. The open-circuit voltage of battery 101B is 3.55 V.

The resistance values of current detection resistor elements 106A and 106B are each 10 mΩ. Current detectors 105A and 105B multiply the respective voltages across the opposite ends of current detection resistor elements 106A and 106B by 100, and detect a voltage of 1V per ampere.

Maximum value detector 130 is configured by a voltage follower circuit shown in FIG. 7.

Current setter 142A outputs 5 V equivalent to the allowable charging current value of battery 101A. Current setter 142B outputs 2.5 V equivalent to the allowable charging current value of battery 101B.

Controller 143 is made of a PID control circuit, and controls the output voltage of charger 120 such that the output value of maximum value detector 130 is 0 V.

When the power of the charge control apparatus of this example is turned on, the output voltage of charger 120 gradually increases according to the command value from controller 143.

When the output voltage of charger 120 reaches 3.50 V that is the open-circuit voltage of battery 101A, charging current starts to flow to battery 101A. At this time, no charging current flows to battery 101B.

When the output voltage of charger 120 reaches 3.50 V that is the open-circuit voltage of battery 101A, current detectors 105A and 105B each output 0 V corresponding to the charging current value of zero.

Error amplifier 141A outputs a value (−5 V) acquired by subtracting the output value (5 V) of current setter 142A from the output value (0 V) of current detector 105A. Meanwhile, error amplifier 141B outputs a value (−2.5 V) acquired by subtracting the output value (2.5 V) of current setter 142B from the output value (0 V) of current detector 105B.

Maximum value detector 130 compares the output value (−5 V) of error amplifier 141A with the output value (−2.5 V) of error amplifier 141B, selects the maximum value of −2.5 V, and supplies the selected value to controller 143.

Since the output value of maximum value detector 130 is a negative value (−2.5 V), controller 143 further increases the output voltage of charger 120.

When the output voltage value of charger 120 reaches 3.55 V that is the open-circuit voltage of battery 101B, the charging current starts to flow also to battery 101B. At this time, the total of the resistance value (10 mΩ) of current detection resistor element 106A and the battery internal resistance value (10 mΩ) of battery 101A is 20 mΩ. Accordingly, a charging current of 2.5 A flows into battery 101A.

When the output voltage value of charger 120 reaches 3.55 V that is the open-circuit voltage of battery 101B, current detector 105A outputs 2.5 V corresponding to the charging current value of 2.5 A, but current detector 105B outputs 0 V corresponding to the charging current value of zero.

Error amplifier 141A outputs a value (−2.5 V) acquired by subtracting the output value (5 V) of current setter 142A from the output value (2.5 V) of current detector 105A. Meanwhile, error amplifier 141B outputs a value (−2.5 V) acquired by subtracting the output value (2.5 V) of current setter 142B from the output value (0 V) of current detector 105B.

The output values of error amplifiers 141A and 141B are each −2.5 V. Accordingly, maximum value detector 130 selects one of the output values of error amplifiers 141A and 141B, and supplies the selected value to controller 143.

Since the output value of maximum value detector 130 is a negative value (−2.5 V), controller 143 further increases the output voltage of charger 120.

When the output voltage of charger 120 reaches 3.60 V, a charging current of 5 A flows into battery 101A. At this time, the total of the resistance value (10 mΩ) of current detection resistor element 106B and the battery internal resistance value (20 mΩ) of battery 101B is 30 mΩ. Accordingly, a charging current of approximately 1.7 A flows into battery 101B. The output current value of charger 120 is 6.7 A.

When the output voltage of charger 120 reaches 3.60 V, current detector 105A outputs 5 V corresponding to the charging current value of 5 A but current detector 105B outputs 1.7 V corresponding to the charging current value of 1.7 A.

Error amplifier 141A outputs a value (0 V) acquired by subtracting the output value (5 V) of current setter 142A from the output value (5 V) of current detector 105A. Meanwhile, error amplifier 141B outputs a value (−0.8 V) acquired by subtracting the output value (2.5 V) of current setter 142B from the output value (1.7 V) of current detector 105B.

Maximum value detector 130 compares the output value (0 V) of error amplifier 141A with the output value (−0.8 V) of error amplifier 141B, selects the maximum value of 0 V, and supplies the selected value to controller 143.

Since the output value of maximum value detector 130 is 0 V, controller 143 maintains the output voltage of charger 120 at the present value, and performs charging at a constant current.

As charging progresses and the open-circuit voltage of battery 101A increases, the charging current starts to decrease. However, controller 143 increases the output voltage of charger 120 such that the maximum value of charging current matches the setting current value.

As charging further progresses and the open-circuit voltage of battery 101A further increases, charging current for battery 101B sometimes reaches the setting value of 2.5 A. At this time, the output voltages of error amplifier 141A and error amplifier 141B are each 0 V. Maximum value detector 130 selects one of output values (0 V) of error amplifiers 141A and 141B, and outputs the selected value to controller 143.

As charging further progresses, the charging current for battery 101B exceeds the setting value of 2.5 A and maximum value detector 130 selects the output value of error amplifier 141B and outputs the selected value to controller 143. Controller 143 controls the output voltage of charger 120 such that the output value of error amplifier 141B is 0 V. In this control, the charging current for battery 101A falls below the setting value of 5 A.

When the output voltage of charger 120 reaches 4.2 V, the charging current falls below the setting value, controller 143 supplies charger 120 with a command value for further increasing the output voltage. However, even if charger 120 receives the command value from controller 143, this charger cannot output a voltage higher than 4.2 V. Accordingly, batteries 101A and 101B are charged at a constant voltage of 4.2 V.

If the output voltage value of charger 120 reaches 4.2 V before the charging current for battery 101B reaches the setting value, the charging voltage will not increase any more. Batteries 101A and 101B are charged at the constant voltage of 4.2 V. In this case, the magnitude of the charging current for battery 101B never reaches the setting current value, and the state transitions to constant-voltage charging.

The charging time in the case where the charging current for battery 101B reaches the setting value and the input of maximum value detector 130 is switched in the middle of charging is longer than the charging time in the case where each of batteries 101A and 101B is separately charged at a constant current and a constant voltage, but shorter than the total of the charging times of batteries 101A and 101B in the case of being separately charged.

The charge control apparatus of the present invention is applicable to a large-capacity battery that includes a plurality of batteries connected in parallel. Such a battery sometimes varies in capacity and characteristics of the batteries. However, the charge control apparatus of the present invention can charge the batteries that have different capacities and states of charge at one time during a short charging period without exceeding the charging upper limit current of each battery.

The present invention has been described above with reference to the exemplary embodiments and examples. However, the present invention is not limited to the foregoing exemplary embodiments and examples. The configuration and operation of the present invention can be modified in various manners allowing those skilled in the art to understand without departing from the spirit of the present invention.

This application claims priority based on Japanese Patent Application No. 2012-98645 filed on Apr. 24, 2012, the disclosure of which is incorporated herein by reference in its entirety.

1. A charge control apparatus comprising:
a charger whose output voltage is variable and to which a plurality of batteries are connected in parallel;
a plurality of current detectors that are provided for each of said batteries, each current detector being configured to detect a charging current flowing to each battery and to output the detected current value;
a maximum value detector that selects a maximum value from among output values of said plurality of current detectors, and that outputs the selected value; and
a controller that controls an output voltage of said charger such that the output value of said maximum value detector matches a setting value.

2. A charge control apparatus comprising:
a charger whose output voltage is variable and to which a plurality of batteries are connected in parallel;
a plurality of current detectors that are provided for each of said batteries, each current detector being configured to detect a charging current flowing to each battery and to output the detected current value;
a plurality of current error output units that are provided for each of said plurality of current detectors, each current error output unit being configured to output a value acquired by subtracting a setting value from the output value of each current detector;
a maximum value detector that selects a maximum value from among the output values of said plurality of current error output units, and that outputs the selected value; and
a controller that controls an output voltage of said charger such that the output value of said maximum value detector is zero.

3. The charge control apparatus according to claim 2, wherein an upper limit value of the charging current is set as the setting value for each of said batteries.

4. The charge control apparatus according to claim 1, further comprising a plurality of reverse-current protectors that are provided for each of a plurality of lines that connects an output line of said charger to said batteries, and that prevent reverse flows of currents from said batteries.

5. The charge control apparatus according to claim 1, wherein each of said plurality of batteries comprises any one item from among a lithium-ion battery, a lithium polymer battery, an electric double layer capacitor, and a lithium-ion capacitor.

6. A charge control method performed by a charge control apparatus which comprises a charger whose output voltage is variable, a plurality of batteries being connected in parallel to the charger, the method comprising:
detecting a charging current flowing to each of said batteries; and controlling an output voltage of said charger such that a maximum value from among detected values of the charging currents of said batteries matches a setting value.

7. A charge control method performed by a charge control apparatus which comprises a charger whose output voltage is variable, a plurality of batteries being connected in parallel to the charger, the method comprising:
detecting a charging current flowing to each of said batteries; acquiring a current error value by subtracting a setting value from the detected value of the charging current; and controlling an output voltage of said charger such that a maximum value from among the current error values of said batteries is zero.

8. The charge control apparatus according to claim 2, further comprising a plurality of reverse-current protectors that are provided for each of a plurality of lines that connects an output line of said charger to said batteries, and that prevent reverse flows of currents from said batteries.

9. The charge control apparatus according to claim 2, wherein each of said plurality of batteries comprises any one item from among a lithium-ion battery, a lithium polymer battery, an electric double layer capacitor, and a lithium-ion capacitor.
